(19) United States
(12) Patent Application Publication
(10) Pub. No.: US 2025/0137804 A1
(43) Pub. Date: May 1, 2025

(54) METHOD FOR PREDICTING A WEATHER CONDITION OF A SURFACE OF A ROAD SEGMENT

(71) Applicant: CONTINENTAL AUTOMOTIVE TECHNOLOGIES GMBH, Hannover (DE)

(72) Inventors: Jonathan BONNET, Toulouse (FR); Fabien DANIEL, Toulouse (FR); Anaïs GOURSOLLE, Toulouse (FR)

(21) Appl. No.: 18/690,962

(22) PCT Filed: Aug. 25, 2022
(86) PCT No.: PCT/EP2022/073656

§ 371 Date: Mar. 11, 2024

(30) Foreign Application Priority Data
Sep. 13, 2021 (FR) FR2109571

(51) Int. Cl. G01C 21/36

(52) U.S. Cl. CPC G01C 21/3691

(57) ABSTRACT

A method for predicting a weather-related surface condition of a particular road segment including partitioning the geographical area into a plurality of weather cells, subdividing the geographical area into regions composed of weather cells sharing similar climatic characteristics, and for each defined region, training at least one prediction model on variables derived from weather observations associated with surface conditions observed in the region in question, and associating each road segment of the network with at least two particular prediction models. The method further including, when a command to predict a surface condition is triggered for a particular road segment, selecting at least the at least two particular models associated with the segment in question, inferring the selected models from meteorological data obtained for the geographic location of the road segment to obtain a plurality of predictions for the segment, and combining the plurality of obtained predictions to obtain a consolidated surface condition for the segment.

### CROSS REFERENCE TO RELATED APPLICATIONS

This application is the U.S. National Phase Application of PCT International Application No. PCT/EP2022/073656, filed Aug. 25, 2022, which claims priority to French Patent Application No. FR2109571, filed Sep. 13, 2021, the contents of such applications being incorporated by reference herein.

### FIELD OF THE INVENTION

The invention relates to field of intelligent transportation, and in particular relates to a method and device for predicting a weather-related surface condition of a road segment.

### BACKGROUND OF THE INVENTION

At the present time advanced driver-assistance systems and autonomous vehicles are undergoing rapid development. In order for these vehicles to be able to drive safely, they must in particular have a perfect knowledge of the surface conditions of the roadway on which they are driving. In particular, weather-related surface conditions, such as water height, temperature or the presence of ice, have a direct influence on vehicle behavior and safety, and in particular on braking distances.

Surface conditions on a particular segment of a road network can to some extent be estimated by a server based on local weather forecasts and observations. Such forecasts are generally available for periods of 15 minutes with a granularity of the order of one kilometer from weather forecasters.

However, for identical weather observations, the observed surface conditions can sometimes differ greatly from one road segment to another.

Thus, the specific context of each road segment needs to be taken into account to reliably estimate a surface condition. To this end, it has been envisioned to use road weather information systems (abbreviated RWIS) placed on certain segments of a road network or a fleet of contributing vehicles to collect information on the state of the roadway. In this way, it is possible to collect data allowing correlations to be drawn between a weather forecast or observation for a particular location and the observed surface conditions. However, maintaining a comprehensive map of the state of the roadway for an entire road network would require a very high number of fixed stations or of contributing vehicles equipped with suitable sensors and a huge amount of information to be continuously processed.

There is therefore a need for a technique allowing surface conditions to be reliably obtained at every point on a road network that does not have the aforementioned drawbacks.

### SUMMARY OF THE INVENTION

To this end, a method is provided for predicting a weather-related surface condition of a particular road segment of a geographical area, the method comprising the following steps:
partitioning the geographical area into a plurality of weather cells,
subdividing the geographical area into regions composed of weather cells sharing similar climatic characteristics,
for each defined region, training at least one prediction model on variables derived from weather observations associated with surface conditions observed in the region in question,
associating each road segment of the network with at least two particular prediction models, at least one of the models being selected from trained models, and when a command to predict a surface condition is triggered for a particular road segment:
selecting at least the at least two particular models associated with the segment in question,
inferring the selected models from meteorological data obtained for the geographic location of the road segment to obtain a plurality of predictions for the segment, and
combining the plurality of obtained predictions to obtain a consolidated surface condition for the segment.

In this way, it is possible to predict a weather-related surface condition for a road segment based on a limited number of prediction models trained to this end. Subdividing the geographical area into regions of uniform climatic characteristics allows a prediction model trained in a particular region to be applied to other locations of the same region while maintaining a good prediction reliability.

In addition, associating at least two distinct prediction models with one particular road segment allows the local specificities of the road segment to be taken into account. The predictions made for this segment are further improved.

The method thus allows a reliable estimation of weather-related surface conditions to be obtained at every point on a road network, without the need for exhaustive field observations.

According to one particular embodiment, prediction of a surface condition for a particular road segment is triggered by receipt, from a vehicle, of a message containing at least one geographic location allowing the road segment to be identified, the method further comprising a step of transmitting the consolidated surface condition to the vehicle.

Thus, the method allows a vehicle driving on a road network to obtain “on demand” a surface condition for a given road segment, and for example for a segment over which it is driving or over which it is likely to drive in the near future. Such a feature allows models to be inferred only when necessary. Computing time is thus limited for segments that are not frequently driven.

According to one particular embodiment, prediction of a surface condition for a particular road segment is triggered by obtainment of at least one new weather datum for the segment, the method further comprising a step of storing the consolidated prediction in association with said road segment.

In this way, a consolidated surface condition predicted for a road segment is always immediately available to a plurality of vehicles. Such a feature is particularly advantageous for very busy road segments on which many vehicles are likely to ask for a surface condition.

According to one particular embodiment, the predictions made by the models associated with the road segment are combined using a conservative approach whereby a level of risk is associated with a predictable surface condition, the consolidated prediction being defined by the prediction associated with the highest risk.

Thus, when a plurality of models associated with a particular road segment predict different surface conditions, the retained prediction is the one that ensures maximum safety. For example, if three models associated with a road segment predict the conditions “dry”, “dry”, and “black ice”, respectively, the retained prediction will be “black ice” as this surface condition has the highest risk. Vehicle settings may then be configured to address the highest risk.

According to one particular embodiment, the predictions made by the models associated with the road segment are combined using a majority approach whereby the consolidated prediction is defined by the class predominantly predicted by the models associated with the road segment.

Such an approach makes it possible to determine the most likely surface condition when the models diverge.

In one particular embodiment, the consolidated prediction is defined by an average of the probabilities predicted by the models associated with the road segment.

It is thus proposed to fuse the probabilities of events to determine an overall probability. Such a feature makes it possible to obtain the most likely prediction when the models diverge.

In one particular embodiment, the at least two models selected for a road segment are selected depending on at least one climatic similarity criterion.

In this way, a segment included in a uniform climatic region such as determined in the subdividing step is associated with at least two models trained on observations made in this region.

In one particular embodiment, the at least two models selected for a road segment are selected to minimize the difference between a consolidated surface condition and an observed surface condition.

Thus a combination of models is obtained that is particularly suitable for the road segment in question, or for the type of segment (country road, motorway, etc.).

According to another aspect, a device for predicting a weather-related surface condition of a particular road segment of a geographical area is provided, the device comprising a processor and a memory in which are stored program instructions configured to implement the following steps, when they are executed by the processor:
partitioning the geographical area into a plurality of weather cells,
subdividing the geographical area into regions composed of weather cells sharing similar climatic characteristics,
for each defined region, training at least one prediction model on variables derived from weather observations associated with surface conditions observed in the region in question,
associating each road segment of the network with at least two particular prediction models, at least one of the models being selected from trained models, and when a command to predict a surface condition is triggered for a particular road segment:
selecting at least the at least two particular models associated with the segment in question,
inferring the selected models from meteorological data obtained for the geographic location of the road segment to obtain a plurality of predictions for the segment, and
combining the plurality of obtained predictions to obtain a consolidated surface condition for the segment.

An aspect of the invention also relates to a server comprising a predicting device such as described above.

An aspect of the invention also relates to a data medium comprising computer-program instructions configured to implement the steps of a predicting method such as described above, when the instructions are executed by a processor.

The data medium may be a non-volatile data medium such as a hard disk, a flash memory or an optical disk for example.

The data medium may be any entity or device capable of storing instructions. For example, the medium may comprise a storage means, such as a ROM, RAM, PROM, EPROM, a CD ROM or even a magnetic recording means, a hard disk for example.

Furthermore, the data medium may be a transmissible medium such as an electrical or optical signal, which is able to be routed via an electrical or optical cable, by radio or by other means. Alternatively, the data medium may be an integrated circuit, into which the program is incorporated, the circuit being suitable for executing or for being used in the execution of the method in question.

The various aforementioned embodiments or features may be added, independently of or in combination with one another, to the steps of the predicting method. The servers, devices and data media have at least advantages which are analogous to those conferred by the method to which they relate.

### BRIEF DESCRIPTION OF THE DRAWINGS

Further features and advantages of aspects of the invention will become more clearly apparent on reading the following description. This description is purely illustrative and should be read in conjunction with the appended drawings, in which:

FIG. 1 shows an environment suitable for implementation of the predicting method according to one particular embodiment.

FIG. 2 is a flowchart showing the main steps of a predicting method according to one particular embodiment.

FIG. 3A shows a map of Germany partitioned into a plurality of weather cells.

FIG. 3B shows a map of Germany on which have been represented by symbols the climatic characteristics of each weather cell shown in FIG. 3A.

### DETAILED DESCRIPTION OF THE PREFERRED EMBODIMENTS

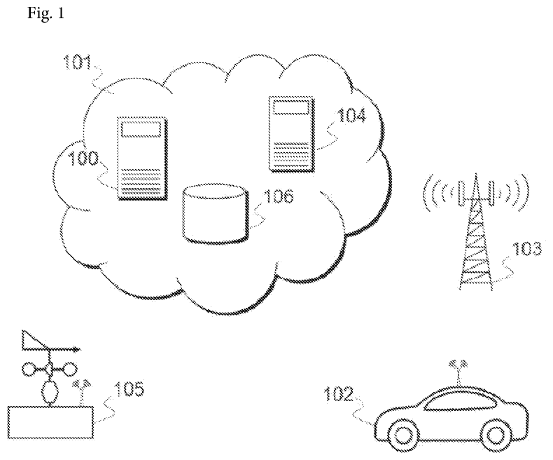

FIG. 1 shows a server 100 of a telecommunications network 101. The server 100 comprises a processor, a memory and a communication interface allowing it to exchange messages with a vehicle 102 via a cellular access network 103 that is interconnected with the communication network 101 and with a server 104 of a provider of weather data. The memory of the server 100 comprises computer-program instructions configured to implement the steps of a predicting method according to one particular embodiment. On initialization, the computer-program instructions are for example loaded into a random access memory (RAM) before being executed by the processor of the server 100. The processor of the server 100 implements the steps of the predicting method according to the computer-program instructions loaded into the memory.

The server 104 is configured to transmit weather forecasts and observations relating to a particular geographical area to the server 101. The server 104 periodically transmits weather data to the server 100, for example every 15 minutes, with a geographical granularity of about 1° longitude and latitude. Of course, different geographical or temporal granularities may be envisaged without modifying an aspect of the invention. For example, the server 104 may transmit weather data with a granularity of the order of 100 km2, 25 km2, or even 1 km2.

The vehicle 102 comprises a wireless communication interface allowing it to connect to the cellular access network 103 with a view to exchanging messages with online cloud services. In particular, the communication interface of the vehicle 102 allows it to consult the server 100 in order in particular to obtain a weather-related surface condition of the road segment over which it is driving and/or over which it will drive in the near future, for example a degree of wetness and/or the height of a film of water on the roadway, the presence or absence of black ice or snow. The communication interface is for example a 2G, 3G, 4G or 5G interface, or a WiFi or WIMAX interface.

The communication interface of the server 100 also allows it to exchange messages with ground stations 105 that are distributed over the territory in question and that are configured to transmit observations on the state of the roadway in various locations of a road network.

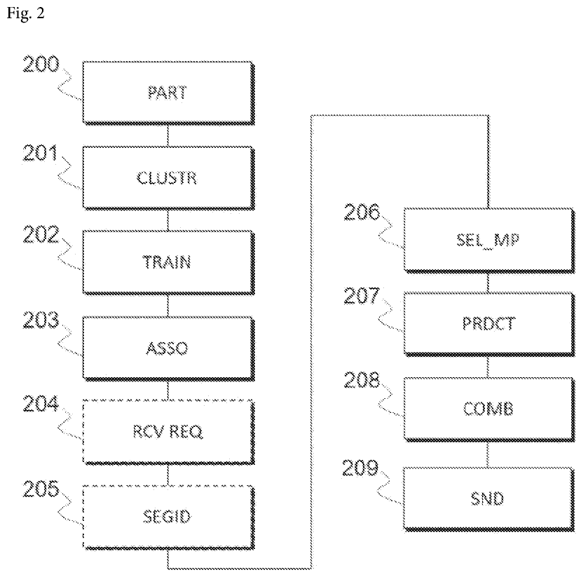

The method for predicting a surface condition of a road segment will now be described with reference to FIG. 2.

FIG. 2 is a flowchart in which the main steps of the method according to one particular embodiment have been shown.

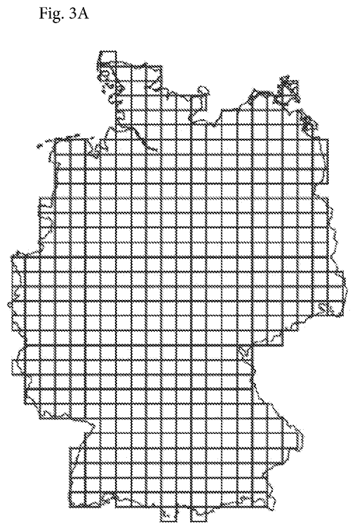

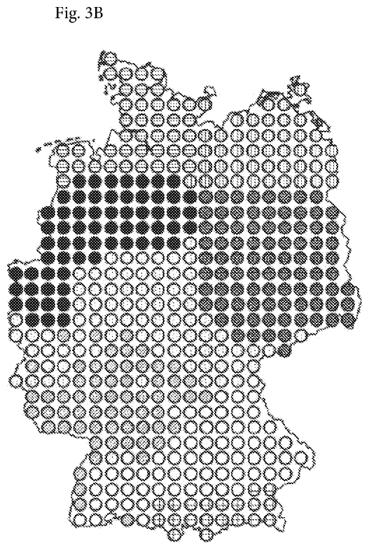

In a first step 200, the server 100 partitions a territory in question into a plurality of cells for which weather forecasts and/or observations are available from the server 104. In FIG. 3A, the example considered is that of a map of Germany partitioned into cells the granularity of which corresponds to the granularity offered by the weather-forecast server 104, i.e. in this example into cells of about 25 km side length.

In a step 201, the server 100 obtains a history of weather observations and/or forecasts for each of the cells defined in step 200. These histories for example have a frequency of one day over the last 5 years. On the basis of the histories thus collected, the server 100 selects, for each of the cells, characteristic data, such as for example, non-exhaustively: minimum, maximum and average temperatures; a daily average of wind speed measured at an altitude of 10 meters; an atmospheric pressure; a total precipitation; or even an evapotranspiration potential. These data are standardized and used to perform an unsupervised classification in order to determine climatically uniform geographical regions, for example mountainous regions, coastal regions, central plains, etc. To do this, the server 100 may implement an unsupervised classification algorithm such as a K-means or DBSCAN algorithm.

FIG. 3B shows a map of Germany on which circles containing different patterns indicate different climatic characteristics identified for each of the cells defined in step 200. The unsupervised classifying step has revealed 8 distinct regions, these regions being such that within a particular region relatively uniform climatic conditions are observed.

In step 202, the server 100 obtains observations relating to surface conditions of at least one road segment for each of the geographical regions determined in step 201. These observations are for example obtained from ground stations such as the station 105 of FIG. 1. Such stations are configured to observe the state of the roadway, i.e. things such as surface temperature, the presence of black ice or snow, surface dryness or wetness, and/or the height of a film of water on the road surface. Such stations may use various types of sensors to make these observations, such as optical or thermal cameras, temperature probes, or anemometers, and transmit the data thus captured to a server such as the server 100. The transmitted data further comprise the type of pavement or of road segment and the location and/or an identifier of the station. Since these stations are expensive and distributed non-uniformly over the road network, the fact that regions with uniform climatic conditions have been defined allows observations made by one ground station to be transposed with confidence to other locations in the same region.

To do this, the server 100 trains at least one prediction model on observations collected by a ground station such as the station 105 and on weather forecasts and/or observations for the weather cell in which the station is located. More precisely, the server associates, in a characteristic vector, on the one hand variables derived from weather forecasts and/or observations (such as atmospheric pressure; the frequency, type and amount of precipitation; temperature; UV index; degree of insolation; or cloud cover thickness) and on the other hand target variables derived from observations made in the field by a station in the same weather cell. Such training allows correlations to be established between weather forecasts or observations in a particular weather cell and the surface conditions of a road segment in that weather cell. It is thus possible to train a plurality of predictive models on any ground truth observed for a road segment of a particular climatic region and on weather forecasts and/or observations for the weather cell in which the road segment is located.

In one particular embodiment, for at least one climatic region identified in step 201 a global prediction model is trained on weather data obtained and field observations obtained for the entire climatic region in question. A generic model applicable at every point in a particular climatic region is thus obtained.

In step 203, the server 100 associates a particular road segment with at least two prediction models selected from the models trained in step 202. The association is for example stored in a database 106 of the server 100.

The selected models are models trained on field observations obtained on road segments comparable to the road segment in question, i.e. segments that share at least one characteristic with the segment in question. It is for example possible to envision these characteristics including the type of road, the type and state of wear of the surface material, the immediate environment (forest, city, etc.), topology and/or the climatic region such as determined in step 201. According to one particular embodiment, the server may also select one or more generic models, applicable to every point in a territory without consideration of a particular climatic zone. Such a model is for example trained on weather data and field observations obtained without consideration of a particular climatic region.

For example, the server will possibly in this way associate a seaside motorway for which it does not have any field observations with a model trained on a motorway in the same climatic region, a generic model and a model trained on a small seaside road.

According to one particular embodiment, when the server 100 has available to it field observations for a particular segment, the models associated with said segment are selected so as to minimize the difference between an observed surface condition and a surface condition determined by combining the predictions made by the selected models.

Step 203 of associating at least two models trained in step 202 with a road segment is repeated for all the road segments of a road network.

In a step 204, the server 100 receives a request from the vehicle 102 driving on the road network. The request contains at least one identifier of the road segment on which the vehicle is driving, or else geographical positioning data allowing the server to determine, in a step 205, by virtue of a digital map of the road network, the road segment on which the vehicle is driving, for example a longitude and latitude of the vehicle or of another location a weather-related surface condition of which the vehicle wishes to know. The request is for example a message conforming to a vehicle-to-infrastructure (V2I) communication protocol and is transmitted to the server 100 via the cellular access network 103 and communication network 101.

In step 206, the server 100 makes a request to the database 106 to obtain the models associated in step 203 with the segment identified in step 205.

In step 207, the server interrogates the server 104 to obtain weather forecasts and/or observations regarding the weather cell in which the identified segment is located and applies this weather data to the prediction models associated with the segment. To do this, the server extracts from the weather data the variables used to train the models (for example, atmospheric pressure; the frequency, type and amount of precipitation; temperature; UV index; degree of insolation; or cloud cover thickness). The server 100 thus obtains a plurality of predicted weather-related surface conditions from the models associated with the segment.

In step 208, the predictions thus obtained are combined to obtain a consolidated prediction of the weather-related surface conditions of the road segment.

According to one particular embodiment, the predictions made by the models associated with the road segment are combined using a conservative approach whereby a level of risk is associated with a predictable surface condition, the consolidated prediction being defined by the prediction associated with the highest risk. In this case, the prediction model is a classification model in which each class corresponds to one particular surface condition, for example “dry”, “black ice”, “snow” or “rain”. With such an approach, if three models associated with a particular segment predict the conditions “dry”, “dry” and “black ice”, respectively, the consolidated prediction will correspond to the prediction associated with the highest risk to the vehicle, i.e. to “black ice”.

According to one particular embodiment, the predictions made by the models associated with the road segment are combined using a majority approach whereby the consolidated prediction is defined by the class predominantly predicted by the models associated with the road segment. In this case, the prediction model is a classification model in which each class corresponds to one particular surface condition, for example “dry”, “black ice”, “snow” or “rain”. With such an approach, if three models associated with a particular segment predict the conditions “dry”, “dry” and “black ice”, respectively, the consolidated prediction will correspond to the class most predicted by the selection of models associated with the segment, i.e. to “dry”. In one particular embodiment, when no class is in the majority, for example in the case of equality, the consolidated prediction is the prediction corresponding to the highest risk. For example, if for a segment with which two models are associated, the first model predicts “black ice” and the second model predicts “dry”, the consolidated prediction will be “black ice” because such a surface condition is linked to a higher risk to driven vehicles.

According to one particular embodiment, the consolidated prediction is defined by an average of the probabilities predicted by the models associated with the road segment. In such an embodiment, the prediction models are configured to predict a probability of occurrence for various classes. The server 100 then computes an average probability from the probabilities of occurrence predicted by the selected models.

Lastly, the server transmits to the vehicle 102 the consolidated surface condition in a step 209 in response to the request received in step 204.

According to one particular embodiment, the models selected for a particular segment are inferred as soon as inference is made possible through obtainment of new weather data and the consolidated prediction is stored in association with the corresponding segment in the database 106. Thus, the server always has available to it, for a particular segment, the latest predictable surface conditions of the segment. Such a feature is advantageous when a high number of vehicles are driving over the segment because it avoids the need to infer the models a plurality of times with identical data, and allows a vehicle to obtain a prediction with improved responsiveness. In contrast, by inferring the models associated with a particular segment “on demand”, i.e. on receipt of a request from a vehicle, computing time is optimized for segments that are not frequently driven.

1. A method for predicting a weather-related surface condition of a particular road segment of a geographical area, the method comprising:
partitioning the geographical area into a plurality of weather cells,
subdividing the geographical area into regions composed of weather cells sharing similar climatic characteristics,
for each defined region, training at least one prediction model on variables derived from weather observations associated with surface conditions observed in the region in question,
associating each road segment of the network with at least two particular prediction models, including a model trained for the region to which the segment in question belongs and a generic model, trained on observations obtained for a comparable segment of the geographical area, without consideration of a particular climatic region, and
when a command to predict a surface condition is triggered for a particular road segment:
selecting at least the at least two particular models associated with the segment in question,
inferring the selected models from meteorological data obtained for the geographic location of the road segment to obtain a plurality of predictions for the segment, and
combining the plurality of obtained predictions to obtain a consolidated surface condition for the segment.

2. The method as claimed in claim 1, wherein the command to predict a surface condition for a particular road segment is triggered by receipt-, from a vehicle, of a message containing at least one geographic location allowing a road segment to be identified, the method further comprising a step of transmitting the consolidated surface condition to the vehicle.

3. The method as claimed in claim 1, wherein the command to predict a surface condition for a particular road segment is triggered by obtainment of at least one new weather datum for the segment, the method further comprising a step of storing the consolidated prediction in association with said road segment.

4. The method as claimed in claim 1, wherein the predictions made by the models selected for the road segment are combined using a conservative approach whereby a level of risk is associated with a predictable surface condition, the consolidated prediction being defined by the prediction associated with the highest risk.

5. The method as claimed in claim 1, wherein the predictions made by the models selected for the road segment are combined using a majority approach whereby the consolidated prediction is defined by the class predominantly predicted by the models associated with the road segment.

6. The method as claimed in claim 1, wherein the consolidated prediction is defined by an average of the probabilities predicted by the models selected for the road segment.

7. The method as claimed in claim 1, wherein the at least two models associated with a road segment are selected depending on at least one climatic similarity criterion.

8. The method as claimed in claim 1, wherein the at least two models associated with a road segment are selected to minimize the difference between a consolidated surface condition and an observed surface condition.

9. A device for predicting a weather-related surface condition of a particular road segment of a geographical area, the device comprising a processor and a memory in which are stored program instructions configured to implement the following steps, when they are executed by the processor:
partitioning the geographical area into a plurality of weather cells,
subdividing the geographical area into regions composed of weather cells sharing similar climatic characteristics,
for each defined region, training at least one prediction model on variables derived from weather observations associated with surface conditions observed in the region in question,
associating each road segment of the network with at least two particular prediction models, including a model trained for the region to which the segment in question belongs and a generic model, trained on observations obtained for a comparable segment of the geographical area, without consideration of a particular climatic region,
when a command to predict a surface condition is triggered for a particular road segment:
selecting at least the at least two particular models associated with the segment in question,
inferring the selected models from meteorological data obtained for the geographic location of the road segment to obtain a plurality of predictions for the segment, and
combining the plurality of obtained predictions to obtain a consolidated surface condition for the segment.

10. A server comprising a device as claimed in claim 9.
